(19) United States
(12) Patent Application Publication
(10) Pub. No.: US 2009/0110356 A1
(43) Pub. Date: Apr. 30, 2009

(54) METHODS AND APPARATUSES FOR WAVEGUIDING LUMINESCENCE GENERATED IN A SCATTERING MEDIUM

(76) Inventors: Xiao-Dong Xiang, Danville, CA (US); Wei Shan, Fremont, CA (US); Zitong Chen, Saratoga, CA (US)

Correspondence Address: BLANK ROME LLP, WATERGATE, 600 NEW HAMPSHIRE AVENUE, N.W., WASHINGTON, DC, 20037, US

(21) Appl. No.: 12/141,513

(22) Filed: Jun. 18, 2008

Related U.S. Application Data
(60) Provisional application No. 60/934,872, filed on Jun. 18, 2007.

(51) Int. Cl. G02B 6/10

(52) U.S. Cl. 385/129

(57) ABSTRACT

The present invention is directed to a luminescent waveguide device, and methods of making thereof, that may be used to convert solar energy into electricity. In particular, the present invention relates to extracting and waveguiding luminescence generated in a scattering medium so as to improve luminescent concentrator performance. By stacking one or a pair of transparent plates of refractive index slightly smaller than that of luminescent plate but still larger than that of air, a much greater fraction of re-emitted light by the embedded luminescent particles can be extracted so that the detrimental effect of particle scattering can be minimized. Additionally, by additionally using a high-efficiency diffractive optic component in the structure to redirect the re-emitted photons with angles falling into the escape zone to much larger angles so these otherwise outgoing photons can be waveguided by total internal reflection. These improvements minimize the critical-angle loss and increase the output light intensity at the ends of the waveguide.

This application claims the priority of U.S. Provisional Patent Application No. 60/934,872, filed Jun. 18, 2007.

### BACKGROUND OF THE INVENTION

1. Field of the Invention

Embodiments of the present invention are directed to the field of optical waveguide technology that optically confines photons of luminescence generated in a luminescent substrate and guides propagation of the light without significant optical loss. The present invention is directed to a luminescent waveguide device, and methods of making thereof, that may be used to convert solar energy into electricity.

2. Description of the Related Art

Solar cells are very important to the solar electric energy generation using PV technology in terms of conversion efficiency and cost-effectiveness. The cost of solar cells currently constitutes about 50% of the total system cost. Approaches to bring down the cost have been primarily focused on two fronts: the first is to reduce the cost of solar cells using new fabrication technology and large scale production. The second is to decrease the usage of expensive solar cells by concentrating as much sunlight as possible to small-area high-efficiency cells.

Conventional methods using lenses and parabolic mirrors have been widely used to concentrate sunlight. However, concentrators employing geometric optic components work only under direct sunlight and require tracking of the sun and excellent heat dissipation. These disadvantages may be overcome using luminescent concentrator (LC) that consists basically of a set of transparent plates embedded with particles of luminescent materials. The incident broad-band sunlight will be absorbed in these plates and re-emitted as narrow-band luminescence isotropically in all directions. The transparent plates of higher refractive index acting as waveguide collectors trap a large portion of re-emitted light that strikes at the surface of the plate with an incident angle larger than the critical angle for total internal reflection defined by Snell's law, and ensure the collection of the trapped light piping down from one point to another undergoing the internal reflection to the edges of the plates in the underlying solar cells (J. Javetski, Electronics, 52, 105 (1979); H. J. Hovel et al., Solar Energy Materials, 2, 19 (1979); U.S. Pat. No. 4,227,939 to A. H. Zewail et al).

The concept of LC for solar energy conversion was introduced in the 1970s. In the earlier version of these concentrators, organic dye molecules dispersed and doped in a transparent glass or plastic substrate with its refractive index larger than air were used to absorb short-wavelength photons of incident sunlight and re-emit them at longer wavelengths, i.e. frequency down conversion, where the solar cells have better spectral response in terms of quantum efficiency, therefore higher energy conversion efficiency can be achieved. Later, the idea was expanded to use inorganic semiconductor quantum dots (U.S. Pat. No. 6,476,3120 to K. W. J. Bamham, and references therein) and nanostructured composite materials (US Patent Application Publication No. US2004/0095658 to M. Buretea et al.) as luminescent materials. Compared to the other types of solar concentrators, LC has several advantages that include: (i) no need for tracking of sun movement is required because the luminescent materials absorb incident light at any angle; (ii) much lower heating generated in the edge-mounted solar cells because the heat from the excess energy of the short-wavelength photons is dissipated over the entire area of the concentrator; (iii) functional under both direct and diffuse sunlight conditions, and (iv) easily scaled-up concentration factor by increasing the area of the collector over its given thickness.

For LC, a fraction of re-emitted luminescence, which depends on the refractive indexes of the collector (n₁) and the surrounding medium (n₀) and given by equation (1)

$$f = 1 - \frac{{( {n}_{1}^{2} - {n}_{0}^{2} )}^{1 / 2}}{{n}_{1}} , \qquad equation ( 1 )$$

escapes out of the transparent substrate when the re-emitted photons fall into an escape cone, as illustrated in FIG. 1, in which their angles of incidence from the collector to the surrounding medium is smaller than the critical angle of total internal reflection. For glass of common refractive index n=1.5 as a transparent plate collector surrounded by air, the fraction of loss is about 25% (a critical angle of 41.8°).

The expected high efficiency of LC in practice has not been reached for various reasons. In the organic dye situation, because absorption and emission spectrum of a dye is very close to each other, and absorption spectrum does not cover enough useful solar spectrum, several dyes have to be used in a cascading fashion (i.e. a second dye absorbing the emission of the first dye and so on) to convert most of the useful solar energy spectrum to a lower energy spectrum. In each step of the cascade, a fraction of energy is lost, multiple cascading steps quickly lose most of the energy. In the inorganic doped-glass situation, to maintain the transparency of the doped glass, i.e. keep a single phase material, very small amounts of luminescent dopant can be added, resulting very low quantum efficiency. If large amounts of luminescent dopant is added, the resulting material contains two phases (one of the glass and one of the luminescent material). This two phase material is opaque and scatters the emitted light.

### SUMMARY OF THE INVENTION

Embodiments of present invention are directed to extracting and waveguiding luminescence generated in a medium so as to improve luminescent concentrator performance. By placing a high-efficiency transmission diffractive optic component and/or glass plate(s) on top of luminescent plates to redirect the re-emitted photons with angles relative to surface normal falling into the escape zone to much larger angles so these otherwise outgoing photons can be waveguided by total internal reflection within the glass plate and to the side edges, therefore minimizing the critical-angle loss and increasing the output light intensity at the edges.

### BRIEF DESCRIPTION OF DRAWINGS

FIG. 1 is a schematic illustration of the escape cone for photons emitted by luminescent particles embedded in a transparent substrate with refractive index of n₁ to surrounding medium with refractive index of n₂, under the conditions of n₁>n₂, with their angles of incidence relative to the surface normal from the substrate to the surrounding medium is smaller than the critical angle of total internal reflection (θ_{c});

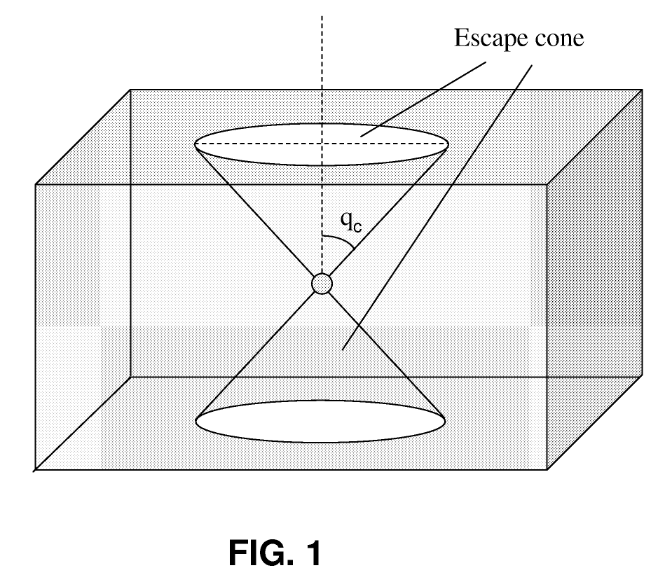

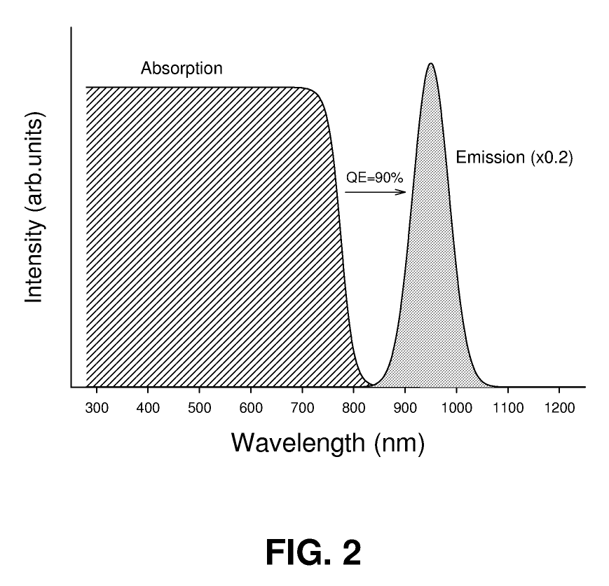

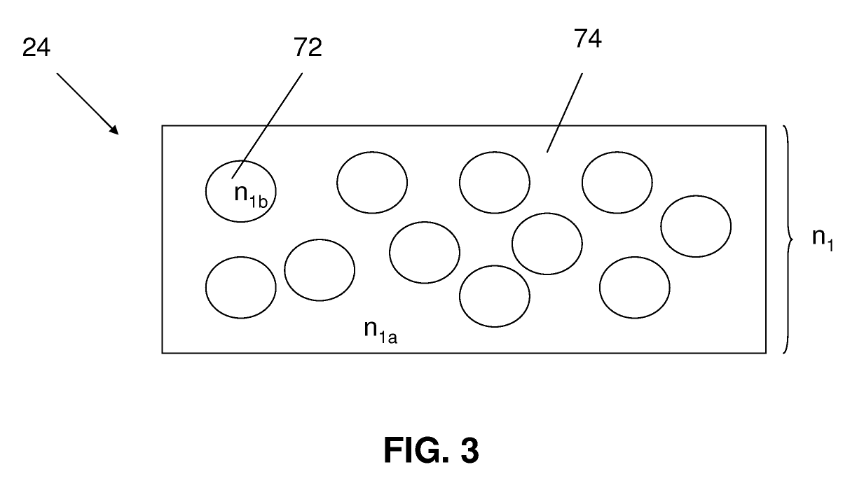

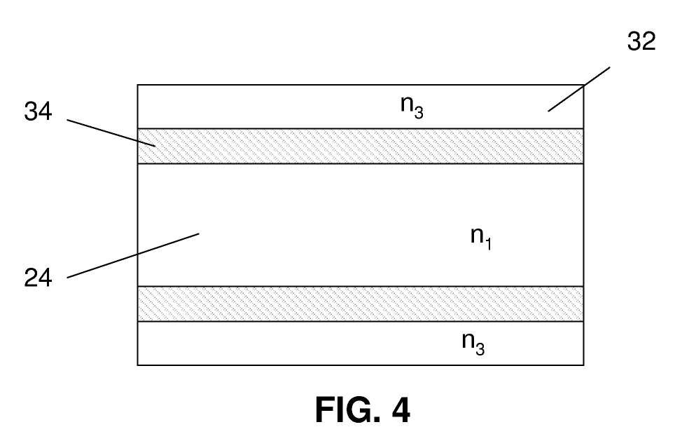

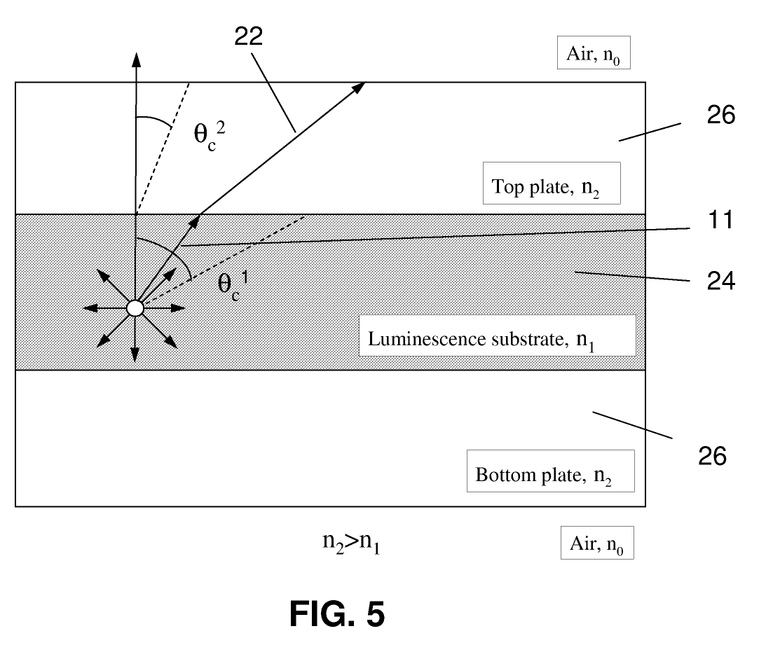

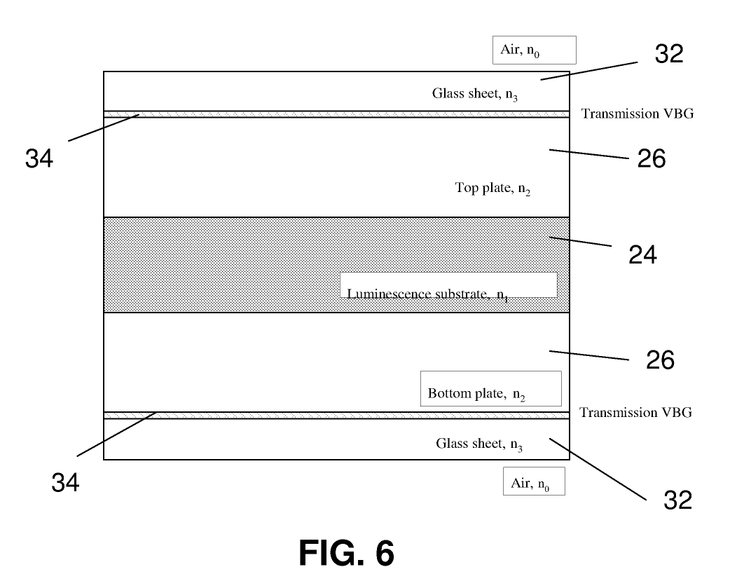

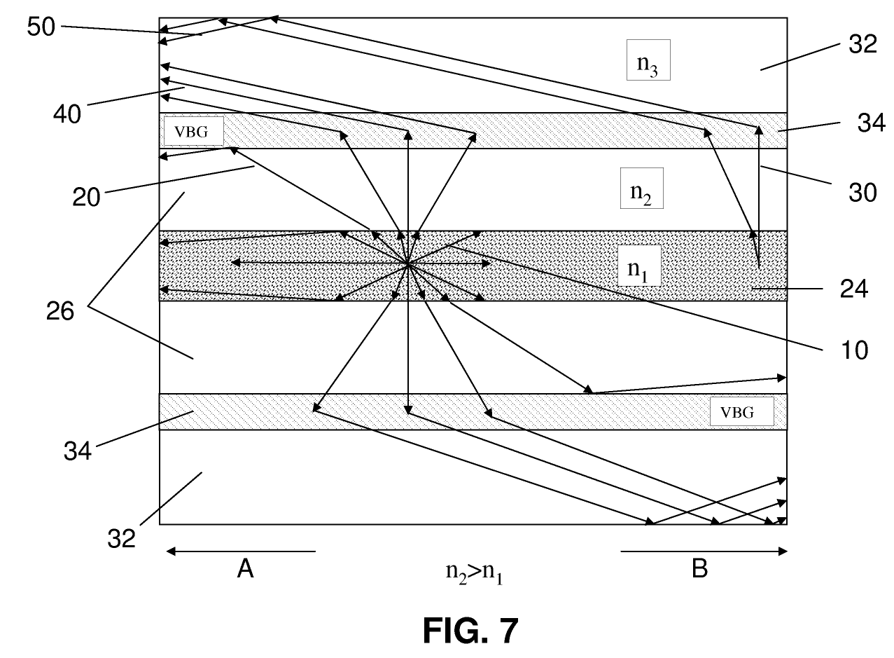

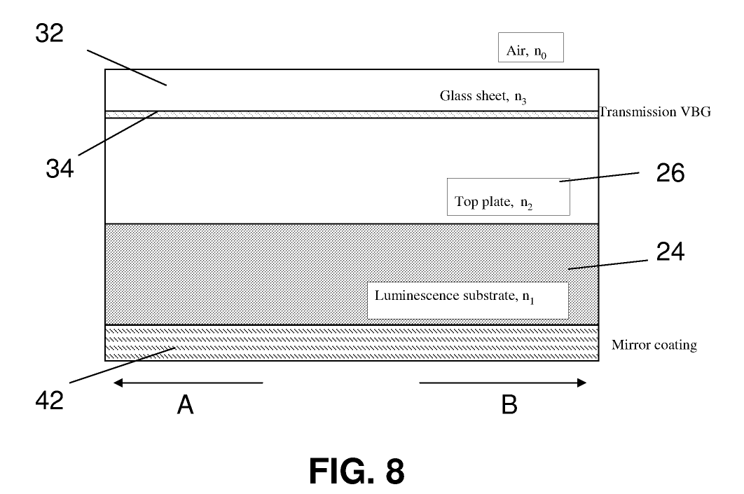

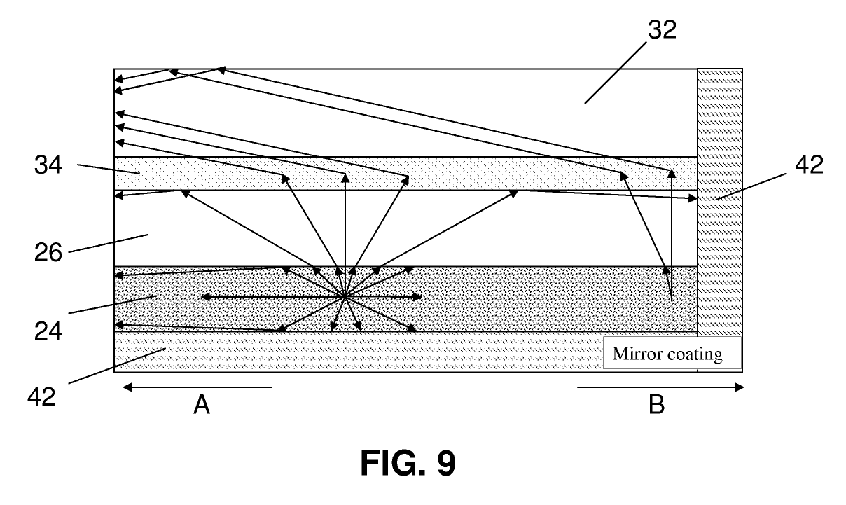

FIG. (2) is schematic illustration of preferred luminescent spectrum.

FIG. (3) is a schematic showing the composition of a multi-phase luminescent substrate;

FIG. (4) is a schematic showing an exemplary symmetrical configuration of a luminescence waveguide with diffractive optics on a glass plate (positioned as diffraction optics in adjacent to luminescent plate and glass plate adjacent to air) installed directly over the luminescent substrate to capture all luminescent light escaping from the top of the luminescent plate with escaping cone angle.

FIG. (5) is a schematic illustration of placing a glass plate with an index of refraction greater than that of the luminescent plate on luminescent substrate to reduce the angle of escape cone of the luminescent plate;

FIG. (6) is a schematic showing an exemplary symmetrical configuration of a luminescence waveguide with diffractive optics (transmission VGB) and cover glass sheet installed;

FIG. (7) is a diagram showing that when a symmetrical waveguide used to confine photons emitted by luminescent particles embedded in the luminescence substrate within device, then the rays of luminescence may be piped down to the end edges of the waveguide;

FIG. (8) is a schematic showing an exemplary asymmetrical configuration of a luminescence waveguide with diffractive optics (transmission VGB) and cover glass sheet installed;

FIG. (9) is a diagram showing that when a symmetrical waveguide used to confine photons emitted by luminescent particles embedded in the luminescence substrate within device, then the rays of luminescence may be piped down to one end edge of the waveguide;

### DETAILED DESCRIPTION OF THE PREFERRED EMBODIMENTS

The foregoing background and summary, as well as the following detailed description of the drawings, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. Throughout the drawings, like reference numerals refer to like elements. The terms “top” and “bottom” are used to distinguish between the different surfaces or covers. The use of the terms does not mean that the apparatus will always be oriented with the “top” surface or cover above the “bottom” surface or cover. Either position is considered to be within the scope of the invention.

To overcome the above-mentioned deficiencies, an alternative luminescent plate designs are proposed in this invention. First, high efficiency inorganic luminescent materials with its absorption and emission spectrum well separated may be used. The luminescent material should be such that its absorption spectrum covers a large portion of useful solar spectrum, and its emission spectrum is located at near and below the upper absorption edge of the photovoltaic semiconductor cell, and at a region with relatively high efficiency and well separated from the absorption spectrum (FIG. 2). If more than one luminescent materials are used to broaden the absorption spectrum, their emission spectra are preferably the same or similar, and have no overlap with any of the absorption spectra.

To ensure the luminescent plate efficiency, a multi-phase approach can be adopted. High concentration of one or more luminescent materials can be mixed with and uniformly dispersed in matrix of non-absorbing (in relevant absorbing and emission spectra) tpolymer, plastic material or other materials. This multi-phase luminescent substrate is depicted in FIG. 3. The luminescent substrate (24) contains a matrix (74) having a refractive index n₁ₐ, and a luminescent particles (72) having a refractive index n_{1b} dispersed therein. The luminescent substrate (24) has an overall average refractive index of n₁.

Such a two phase or multiple phase medium is a scattering medium. The scattering of irradiance illuminated on it depends on the size, shape, composition, or orientation of the embedded particles. Luminescence generated in such a medium suffers a great deal of scattering en route to reach the ends or edges of the substrate. The portion of luminescence generated by one particular particle and optically confined in the plate by total internal reflection is subjected to scattering by the other particles while propagating in a plate toward the edges. For a N multiple scattering process the internally trapped portion become [1−f]^{N}, and as a result, most luminescent light will escape from the top surface within escape cone and very little is trapped internally and guided to the edge end. The performance of an LC can be impaired severely by multiple scattering processes that prevent the luminescence from transmitting to the edges. For these reasons, it is extremely important to find a methods to address the effects of multiple scattering process.

First, the effect of scattering can be significantly reduced if the matrix material can be made to have its refractive index match closely to that of the luminescent particles. Here, the luminescent material(s) (74) and the matrix (72) are selected so that their refractive indexes (n_{1b} and n₁ₐ) are approximately the same, within 20% of each other, preferably within 10%, more preferably within 1%. The closer the refractive indexes are matched the lower the scattering effect. It is desirable to eliminate as much of the scattering effect as possible to ensure efficient transmission of the transmission of the luminescence to the edges of the substrate; therefore, it is most preferred to have n_{1b}=n₁ₐ. This substrate, where the refractive indexes of the matrix (72) and the luminescent material(s) are approximately the same, will appear as transparent, can be used alone as a LC, or be used with the multi-layer apparatuses and structures disclosed below.

Secondly, if the refractive indexes of the matrix (72) and the luminescent material(s) are not matched, the plate will appear as translucent or non-transparent, most luminescent light will escape from the top surface of the plate within the escape cone. The waveguide apparatuses and structures disclosed henceforth can be used to efficiently re-direct and guide the light to the ends or edges of a waveguide. These waveguide apparatuses and structures are designed to internally reflect as much re-emitted light as possible and to conduct the re-emitted to the ends or edges of the waveguide.

Referring to FIG. 5, in an embodiment of the present invention, if the luminescent substrate (24) has an very low overall average refractive index of n₁ (e.g. lower than that of the glass) resulting a fairly large angle escape cone, the top and/or bottom surfaces of a luminescent substrate (24) may be covered by highly transparent plates (26). The plates (26) may be made of highly transparent glass with its index of refraction (n₂) greater than that of the substrate matrix material (n₁), therefore decreasing the escape cone angle of the light of the top surface. In such a configuration, a portion of escaped photons from the top surface of the luminescent substrate (24) can be trapped in the cover plates (26) by internal reflection where they may propagate to the end edges freely without being scattered. Photons with angles of incidence relative to the surface normal smaller than the critical angle for total internal reflection, which is determined by the refractive indexes of the substrate and the cover plates according to Snell's law,

θ_{c}¹=sin⁻¹(n₁/n₂), (2)

will enter the cover plates. If multiple scattering occurs, most light will escape within this cone angle. As shown in FIG. 5, a ray of luminescence (11) with the incident angle relative to the surface normal smaller than θ_{c}¹ may escape from the luminescent substrate (24) into the top cover plate (26). Of the total flux of photons admitted into the covers (26), a fraction will escape from the top surface for they fall into the escape cone defined by the critical angle of θ_{c}² for total internal reflection at the interface between the cover plate (26) and the air. The rest will be optically confined within the device structure. As shown in FIG. 5, the propagation of the ray of luminescence (22) is waveguided in the plate for its incident angle is larger than θ_{c}².

In certain embodiments, diffractive optics (34) may be mounted on the surfaces of the top and/or bottom plates (26), as illustrated by FIG. 6, or directly on the luminescent plate (if the escape cone angle of the luminescent plate is not too large), then further be covered by a glass sheet (32) for wave guiding, support of refraction optical layer and UV protection of the layer, as illustrated in FIG. 4. The optics (34) is designed to specifically change the propagating direction of those escaping photons into a range of angles that satisfy the requirement for total internal reflection at the interface of the glass cover sheet and the air. The function of this optical device is to capture all light escaping from the top surface and re-directed to the end edge of the cover glass. This configuration and effect can be realized for all transparent or non-transparent, organic or inorganic, single phase or multi-phase luminescent substrate forming a highly effective LC.

The diffractive optic (34) is preferably a transmission diffraction grating which is a collection of reflecting elements that are separated by a distance comparable to the wavelengths of interest (grating constant). The elements can be a periodic thickness variation (surface relief) of a transparent material or a periodic refractive-index variation (volume) within a flat film formed along one dimension. When the thickness of a grating significantly exceeds the fundamental fringe period recorded in it, the grating is said to operate in the Bragg diffraction regime and is called a volume Bragg grating (VBG). The extended volume of its medium serves to suppress (or “filter out”) all but the first diffraction order in reconstruction; therefore, the efficiency is very high. VBG may be holographically made using two unit amplitude plane waves of common wavelength that are incident on a photosensitive medium making angles with the surface normal. The arrangement of incidence on the same side of the photosensitive medium records a transmission hologram, whereas incidence from opposite sides of the medium forms a reflection hologram. Since the angles of incidence and diffraction, central wavelength, and spectral, as well as angular widths, of a VBG can be properly chosen by varying the grating thickness, period of refractive index modulation, and grating vector orientation, it is considered a very useful angular as well as spectral selector. In addition, the selectivity property of a VBG endowed by the physics of volume diffraction can be exploited to multiplex a number of holograms that are stored within the same physical volume and then diffract lights incident from different angles independently, thus greatly enhancing the overall capabilities of the volume grating to accept lights incident from a wide range of angles within a given spectral breadth and diffract them to the same location.

A transmission VBG may be made by recording several holograms angularly multiplexed within the same physical volume of the grating, and may be readily integrated into a luminescence waveguide with their spectral bandwidth matching to the re-emission of the luminescent particles.

Referring to FIGS. 6 and 7, a luminescence waveguide in accordance with the present invention contains of a luminescent substrate (24) having an averaged refractive index of n₁; a pair of transparent plates (26) with refractive index of n₂, covering the top and bottom of the luminescent substrate (24); and a transmission VBG (34) on top of each plate (26) followed a glass cover sheet (32), respectively. The VBG (34) is refractive index matched to that of the glass cover (32) (n₃). Photons re-emitted by luminescent particles after photo-excitation with larger than the critical angle (10), which is determined by n₁ and n₂ according to Eq. (2), are to be ‘piped’ within the substrate (24) toward directions A and B by total internal reflection. Those re-emitted photons of smaller-than-the-critical-angle are to enter the top and bottom plates (26) covering the substrate. Part of those (20) will be total-internally reflected at the interface between the plate (26) and the VBG (34), traveling to directions A and B. The rest of them (30) falling into the escape cone as defined by n₂ and n₃ will go out of the transparent plates to strike onto the angularly-multiplexed VBGs (34). The optic (34) diverts those outgoing photons (40) into an angle relative to the surface normal much larger than that is required for total internal reflection. The fraction of photons to be lost otherwise (50) is optically confined by the glass cover plate. In this scheme, if a multi-phase luminescent substrate is used, the loss due to refractive index mismatch between the substrate matrix material and the luminescent particles can be minimized. In this way, nearly all the re-emitted photons by the luminescent particles embedded in the substrate (24) may be waveguided toward the edges in directions A and B.

In another embodiment, the diffractive optic (34) and protective glass cover (32) can replace the cover plates (26), as illustrated in FIG. 4. In this embodiment, the top and bottom surface of the luminescent substrate (24) is covered by a diffractive optic (34) which is further covered by a glass sheet (32) for protection. The luminescent substrate (24) has a refractive index n₁; and the cover (32) has a refractive index n₃. Preferably, n₁ is less than n₃. Here, the re-emitted photons from the luminescent substrate (24) falling into the escape cone as defined by n₁ and n₃ will go out of the luminescent substrate (24) to strike onto the diffractive optic (34) which diverts those outgoing photons into an angle relative to the surface normal much larger than that is required for total internal reflection. These diverted photons is then optically confined by the cover plate (32).

In another embodiment, an asymmetrical configuration of luminescence waveguide may be used. Referring FIG. 8, the bottom part of a previously described symmetrical luminescent waveguide may be replaced by a mirror coating (42). The coating (42) reflects the bottom half of the total luminescence flux generated in the substrate back toward the top half of the waveguide. All reflected photons is optically confined in the waveguide and piped down to the end edges (toward directions A and B) as well. In this way, the device structure may be much more compact than the previously described symmetrical configuration. Note that this asymmetric configuration may result in, due to the angular selectivity of the transmission VGB, an uneven illumination on the end edges that may be undesirable in some luminescent waveguide applications, such as solar concentration.

A scheme to minimize this undesirable effect of the asymmetrical device structure is to waveguide the re-emitted photon toward just one end of the waveguide (for example, in direction A) by mirror coating the less-illuminated edge (for example, the edge toward direction B) of the waveguide, as illustrated in FIG. 9. In this scheme, the photon traveling in direction B is reflected to the opposite end (toward direction A) by the mirror coating resulting most of the light being waveguided in a single direction (direction A, in this case).

Although the asymmetrical device has been shown in FIGS. 8 and 9 as being applicable to a structure including a luminescent substrate (24), a transparent plate (26), a diffractive optic (34) and a cover plate (32), mirror coating on one or more surfaces is also applicable to other structures disclosed herein.

The multi-layer apparatuses and configurations disclosed herein can be realized for transparent or non-transparent, organic (containing organic dyes) or inorganic (containing inorganic luminescent particles), single phase or multi-phase luminescent substrate to form a highly effective LCs.

Although certain embodiments and preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A waveguide comprising
a. a luminescent substrate having an average refractive index n₁; and
b. a transparent plate covering a surface of the luminescent substrate, the transparent plate having a refractive index n₂, wherein n₂ is greater than n₁ and greater than a refractive index of air.

2. The waveguide of claim 1, further comprising
a. a diffractive optic covering a surface of the transparent plate; and
b. a transparent cover covering a surface of the diffractive optic, the diffractive optic and the transparent cover having a refractive index n₃.

3. The waveguide of claim 2, further comprising a mirror coating on another surface of the luminescent substrate.

4. The waveguide of claim 2, where the diffractive optic is a volume Bragg grating.

5. The waveguide of claim 2, wherein the transparent cover is glass.

6. The waveguide of claim 2, further comprising
a. a second transparent plate covering a second surface of the luminescent substrate, the second transparent plate having a refractive index n₂;
b. a second diffractive optic covering a surface of the second transparent plate; and
c. a second transparent cover covering a surface of the second diffractive optic, the second diffractive optic and the second transparent cover having a refractive index n₃.

7. The waveguide of claim 1, further comprising a mirror coating on another surface of the luminescent substrate.

8. The waveguide of claim 1, further comprising a second transparent plate covering a second surface of the luminescent substrate, the second transparent plate having a refractive index n₂.

9. The waveguide of claim 1, wherein the luminescent substrate is a multi-phase substrate or single phase substrate.

10. The waveguide of claim 1, wherein the luminescent substrate comprises a matrix having a refractive index n₁ₐ and luminescent particles having a refractive index n₁ₐ dispersed therein.

11. The waveguide of claim 10, wherein the matrix is a polymer.

12. The waveguide of claim 10, wherein the luminescent particles are inorganic or organic.

13. A method for making a waveguide comprising the steps of
a. providing a luminescent substrate having an average refractive index n₁; and
b. covering a surface of the luminescent substrate with a transparent plate having a refractive index n₂, wherein n₂ is greater than n₁.

14. The method of claim 13, further comprising the steps of
a. covering a surface of the transparent plate with a diffractive optic; and
b. covering a surface of the diffractive optic with a transparent cover, the diffractive optic and the transparent cover having a refractive index n₃.

15. The method of claim 14, further comprising the step of coating another surface of the luminescent substrate with a mirror to reflect the light back into the substrate.

16. The method of claim 14, further comprising the steps of
a. covering a second surface of the luminescent substrate with a second transparent plate covering, the second transparent plate having a refractive index n₂;
b. covering a surface of the second transparent plate with a second diffractive optic; and
c. covering a second a surface of the second diffractive optic with a second transparent cover, the second diffractive optic and the second transparent cover having a refractive index n₃.

17. The method of claim 14, wherein the diffractive optic is a volume Bragg grating.

18. The method of claim 13, further comprising the step of coating another surface of the luminescent substrate with a mirror to reflect the light back into the substrate.

19. The method of claim 13, wherein the luminescent substrate is a multi-phase substrate or a single phase substrate.

20. The method of claim 13, wherein the luminescent substrate comprises a matrix having a refractive index n₁ₐ and luminescent particles having a refractive index n₁ₐ dispersed therein.

21. The method of claim 20, wherein the matrix is a polymer.

22. The method of claim 20, wherein the luminescent particles are inorganic or organic.

23. A multi-phase luminescent substrate comprising
a. a transparent matrix having a refractive index n₁ₐ; and
b. luminescent particles having a refractive index nib dispersed within the transparent matrix, wherein n₁ₐ and nib are approximately equal.

24. The substrate of claim 23, wherein the transparent matrix is a polymer.

25. The substrate of claim 23, wherein the luminescent particles are inorganic or organic.

26. A method for making a multi-phase luminescent substrate comprising the steps of
a. providing a transparent matrix having a refractive index n₁ₐ;
b. providing luminescent particles having a refractive index nib, wherein n₁ₐ and nib are approximately equal; and
c. dispersing the luminescent particles within the transparent matrix, wherein n₁ₐ and nib are approximately equal.

27. The method of claim 26, wherein the transparent matrix is a polymer.

28. The method of claim 26, wherein the luminescent particles are inorganic.

29. A waveguide comprising
a. a luminescent substrate having an average refractive index n₁; and
b. a diffractive optic covering a surface of the luminescent substrate; and
c. a transparent cover covering a surface of the diffractive optic, the diffractive optic and the transparent cover having a refractive index n₃.

30. The waveguide of claim 29, where the diffractive optic is a volume Bragg grating.

31. The waveguide of claim 29, wherein the transparent cover is glass.

32. The waveguide of claim 29, further comprising a mirror coating on another surface of the luminescent substrate.

33. The waveguide of claim 29, further comprising
a. a second diffractive optic covering another surface of the luminescent substrate; and
b. a second transparent cover covering a surface of the second diffractive optic, the second diffractive optic and the second transparent cover having a refractive index n₃.

34. The waveguide of claim 29, wherein the luminescent substrate is a multi-phase substrate or a single phase substrate.

35. The waveguide of claim 29, wherein the luminescent substrate comprises a transparent matrix having a refractive index n₁ₐ and luminescent particles having a refractive index n₁ₐ dispersed therein.

36. The waveguide of claim 35, wherein the matrix is a polymer.

37. The waveguide of claim 35, wherein the luminescent particles are inorganic or organic.

38. A method for making a waveguide comprising the steps of
a. providing a luminescent substrate having a refractive index n₁; and
b. covering a surface of the luminescent substrate with a diffractive optic; and
c. covering a surface of the diffractive optic with a transparent cover, the diffractive optic and the transparent cover having a refractive index n₃.

39. The method of claim 38, where the diffractive optic is a volume Bragg grating.

40. The method of claim 38, wherein the transparent cover is glass.

41. The method of claim 38, further comprising a mirror coating on another surface of the luminescent substrate.

42. The method of claim 38, further comprising
a. covering another surface of the luminescent substrate with a second diffractive optic; and
b. covering a surface of the second diffractive optic with a second transparent cover, the second diffractive optic and the second transparent cover having a refractive index n₃.

43. The waveguide of claim 38, wherein the luminescent substrate is a multi-phase substrate or a single phase substrate.

44. The waveguide of claim 38, wherein the luminescent substrate comprises a transparent matrix having a refractive index n₁ₐ and luminescent particles having a refractive index n₁ₐ dispersed therein.

45. The waveguide of claim 44, wherein the matrix is a polymer.

46. The waveguide of claim 44, wherein the luminescent particles are inorganic or organic.

47. A method for confining photons within a waveguide comprising the steps of
a. providing the waveguide of claim 1; and
b. exciting the luminescent particles.
